(19) United States
(12) Patent Application Publication
(10) Pub. No.: US 2026/0006552 A1
(43) Pub. Date: Jan. 1, 2026

(54) MONITORING OCCASION COLLISION MANAGEMENT ASSOCIATED WITH A LOW-POWER WAKE-UP RADIO

(71) Applicant: QUALCOMM INCORPORATED, San Diego, CA (US)

(72) Inventors: Chao WEI, Beijing (CN); Yuchul KIM, San Diego, CA (US); Ahmed ELSHAFIE, San Diego, CA (US); Hao XU, Beijing (CN); Wei YANG, San Diego, CA (US)

(21) Appl. No.: 18/880,723

(22) PCT Filed: Aug. 26, 2022
(86) PCT No.: PCT/CN2022/115129

§ 371 Date: Jan. 2, 2025

(51) Int. Cl. H04W 52/02

(52) U.S. Cl. CPC H04W 52/0235; H04W 52/028

(57) ABSTRACT

Various aspects of the present disclosure generally relate to wireless communication. In some aspects. a user equipment (UE) may monitor. using a low-power (LP) wake-up-radio (LP-WUR) and based on an LP monitoring configuration. at least one of an LP-wake-up-signal (LP-WUS) occasion or an LP-synchronization-signal (LP-SS) occasion during at least one monitoring occasion. wherein the at least one monitoring occasion corresponds to a collision, in a time domain. between the LP-WUS occasion and the LP-SS occasion. The UE may receive the at least one of an LP-WUS or an LP-SS during the at least one monitoring occasion. Numerous other aspects are described.

### FIELD OF THE DISCLOSURE

Aspects of the present disclosure generally relate to wireless communication and to techniques and apparatuses for monitoring occasion collision management associated with a low-power wake-up radio.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to monitor, using a low-power (LP) wake-up-radio (LP-WUR) and based on an LP monitoring configuration, at least one of an LP-wake-up-signal (LP-WUS) occasion or an LP-synchronization-signal (LP-SS) occasion during at least one monitoring occasion, wherein the at least one monitoring occasion corresponds to a collision, in a time domain, between the LP-WUS occasion and the LP-SS occasion. The one or more processors may be configured to receive the at least one of an LP-WUS or an LP-SS during the at least one monitoring occasion.

Some aspects described herein relate to a network node for wireless communication. The network node may include a memory and one or more processors coupled to the memory. The one or more processors may be configured to transmit, to a UE comprising an LP-WUR, configuration information indicative of an LP monitoring configuration corresponding to a monitoring operation associated with at least one of an LP-WUS occasion or an LP-SS occasion. The one or more processors may be configured to transmit at least one of an LP-WUS or an LP-SS during at least one monitoring occasion, wherein the at least one monitoring occasion corresponds to a collision, in a time domain, between the LP-WUS occasion and the LP-SS occasion.

Some aspects described herein relate to a method of wireless communication performed by a UE. The method may include monitoring, using an LP-WUR and based on an LP monitoring configuration, at least one of an LP-WUS occasion or an LP-SS occasion during at least one monitoring occasion, wherein the at least one monitoring occasion corresponds to a collision, in a time domain, between the LP-WUS occasion and the LP-SS occasion. The method may include receiving the at least one of an LP-WUS or an LP-SS during the at least one monitoring occasion.

Some aspects described herein relate to a method of wireless communication performed by a network node. The method may include transmitting, to a UE comprising an LP-WUR, configuration information indicative of an LP monitoring configuration corresponding to a monitoring operation associated with at least one of an LP-WUS occasion or an LP-SS occasion. The method may include transmitting at least one of an LP-WUS or an LP-SS during at least one monitoring occasion, wherein the at least one monitoring occasion corresponds to a collision, in a time domain, between the LP-WUS occasion and the LP-SS occasion.

Some aspects described herein relate to a non-transitory computer-readable medium that stores a set of instructions for wireless communication by a UE. The set of instructions, when executed by one or more processors of the UE, may cause the UE to monitor, using an LP-WUR and based on an LP monitoring configuration, at least one of an LP-WUS occasion or an LP-SS occasion during at least one monitoring occasion, wherein the at least one monitoring occasion corresponds to a collision, in a time domain, between the LP-WUS occasion and the LP-SS occasion. The set of instructions, when executed by one or more processors of the UE, may cause the UE to receive the at least one of an LP-WUS or an LP-SS during the at least one monitoring occasion.

Some aspects described herein relate to a non-transitory computer-readable medium that stores a set of instructions for wireless communication by a network node. The set of instructions, when executed by one or more processors of the network node, may cause the network node to transmit, to a UE comprising an LP-WUR, configuration information indicative of an LP monitoring configuration corresponding to a monitoring operation associated with at least one of an LP-WUS occasion or an LP-SS occasion. The set of instructions, when executed by one or more processors of the network node, may cause the network node to transmit at least one of an LP-WUS or an LP-SS during at least one monitoring occasion, wherein the at least one monitoring occasion corresponds to a collision, in a time domain, between the LP-WUS occasion and the LP-SS occasion.

Some aspects described herein relate to an apparatus for wireless communication. The apparatus may include means for monitoring, using an LP-WUR and based on an LP monitoring configuration, at least one of an LP-WUS occasion or an LP-SS occasion during at least one monitoring occasion, wherein the at least one monitoring occasion corresponds to a collision, in a time domain, between the LP-WUS occasion and the LP-SS occasion. The apparatus may include means for receiving the at least one of an LP-WUS or an LP-SS during the at least one monitoring occasion.

Some aspects described herein relate to an apparatus for wireless communication. The apparatus may include means for transmitting, to a UE comprising an LP-WUR, configuration information indicative of an LP monitoring configuration corresponding to a monitoring operation associated with at least one of an LP-WUS occasion or an LP-SS occasion. The apparatus may include means for transmitting at least one of an LP-WUS or an LP-SS during at least one monitoring occasion, wherein the at least one monitoring occasion corresponds to a collision, in a time domain, between the LP-WUS occasion and the LP-SS occasion.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with low-power wake-up-radio (LP-WUR) operations, in accordance with the present disclosure.

FIG. 5 is a diagram illustrating an example associated with monitoring occasion collision management associated with an LP-WUR, in accordance with the present disclosure.

FIG. 6 is a diagram illustrating an example associated with monitoring occasion collision management associated with an LP-WUR, in accordance with the present disclosure.

FIG. 7 is a diagram illustrating an example associated with monitoring occasion collision management associated with an LP-WUR, in accordance with the present disclosure.

FIG. 8 is a diagram illustrating an example associated with monitoring occasion collision management associated with an LP-WUR, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

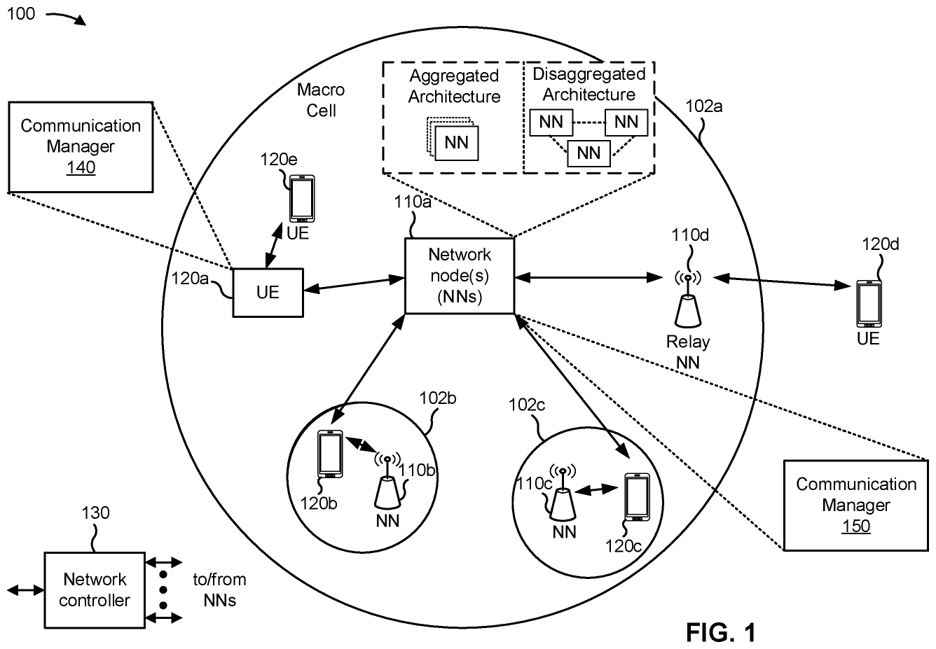

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may monitor, using a low-power (LP) wake-up-radio (LP-WUR) and based on an LP monitoring configuration, at least one of an LP-wake-up-signal (LP-WUS) occasion or an LP-synchronization-signal (LP-SS) occasion during at least one monitoring occasion, wherein the at least one monitoring occasion corresponds to a collision, in a time domain, between the LP-WUS occasion and the LP-SS occasion; and receive the at least one of an LP-WUS or an LP-SS during the at least one monitoring occasion. Additionally, or alternatively, the communication manager 140 may perform one or more other operations described herein.

In some aspects, the network node 110 may include a communication manager 150. As described in more detail elsewhere herein, the communication manager 150 may transmit, to a UE comprising an LP-WUR, configuration information indicative of an LP monitoring configuration corresponding to a monitoring operation associated with at least one of an LP-WUS occasion or an LP-SS occasion; and transmit at least one of an LP-WUS or an LP-SS during at least one monitoring occasion, wherein the at least one monitoring occasion corresponds to a collision, in a time domain, between the LP-WUS occasion and the LP-SS occasion. Additionally, or alternatively, the communication manager 150 may perform one or more other operations described herein.

As indicated above, FIG. 1 is provided as an example. Other examples may differ from what is described with regard to FIG. 1.

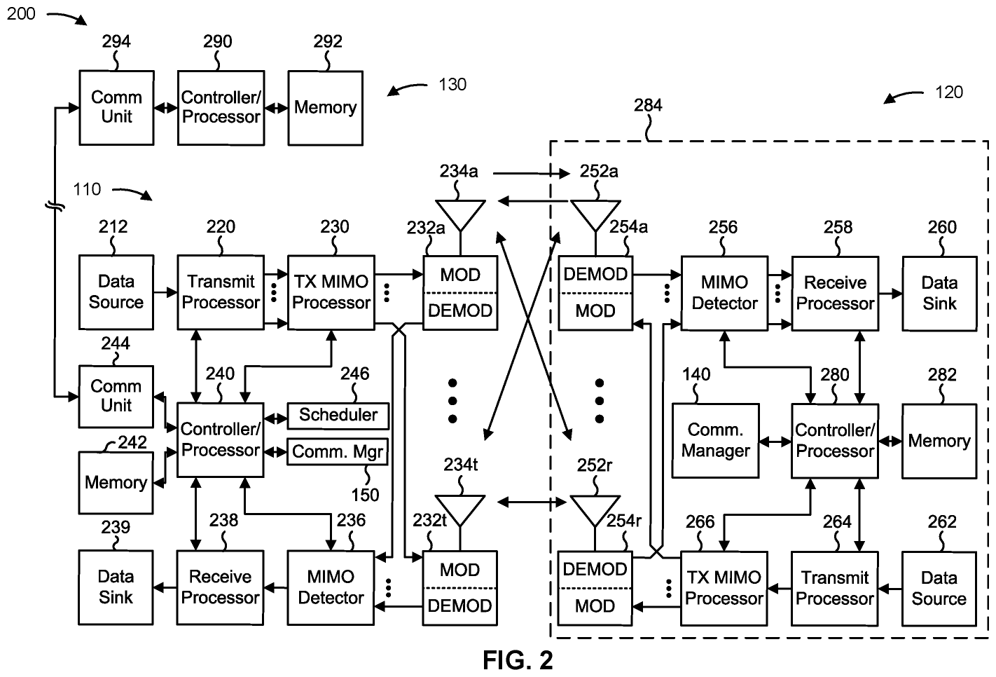

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

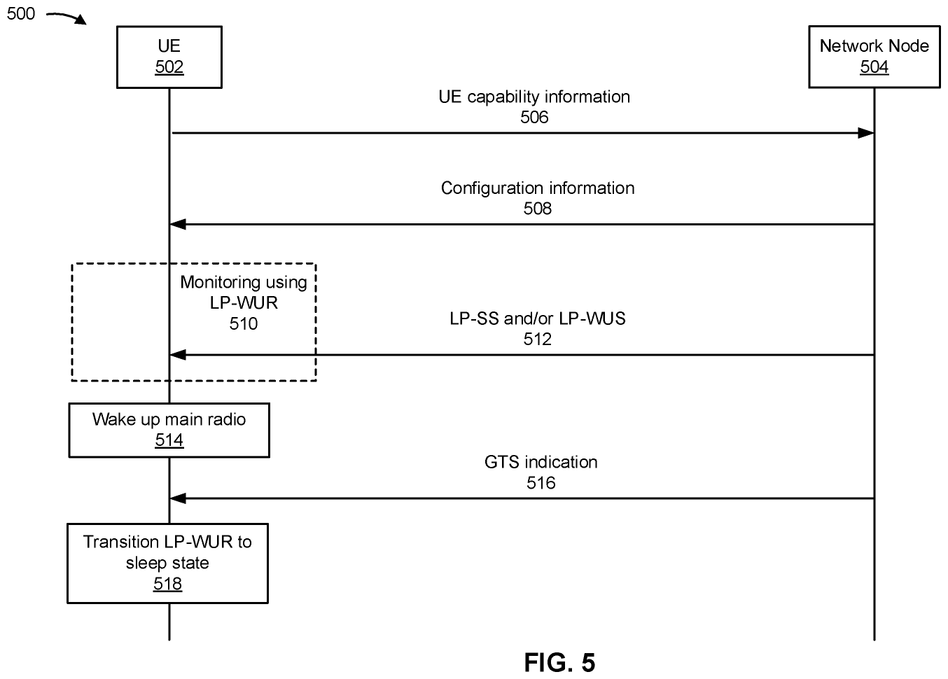

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

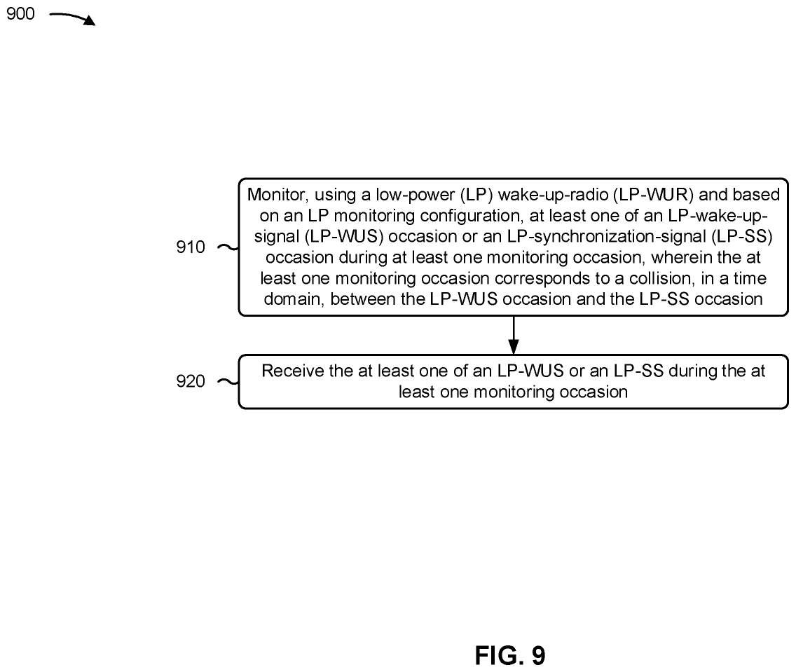

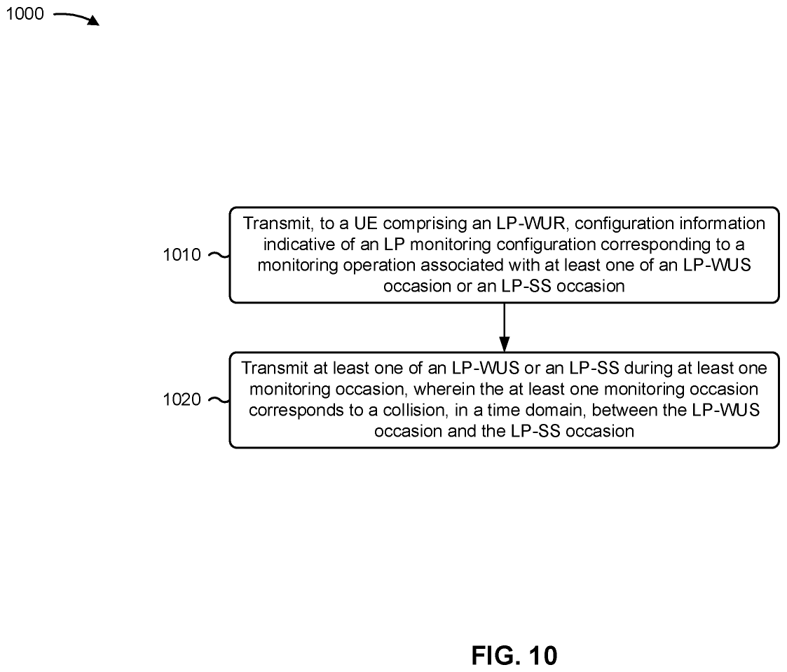

The controller/processor 240 of the network node 110, the controller/processor 280 of the UE 120, and/or any other component(s) of FIG. 2 may perform one or more techniques associated with monitoring occasion collision management associated with a LP-WUR, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for monitoring, using an LP-WUR and based on an LP monitoring configuration, at least one of an LP-WUS occasion or an LP-SS occasion during at least one monitoring occasion, wherein the at least one monitoring occasion corresponds to a collision, in a time domain, between the LP-WUS occasion and the LP-SS occasion; and/or means for receiving the at least one of an LP-WUS or an LP-SS during the at least one monitoring occasion. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE comprising an LP-WUR, configuration information indicative of an LP monitoring configuration corresponding to a monitoring operation associated with at least one of an LP-WUS occasion or an LP-SS occasion; and/or means for transmitting at least one of an LP-WUS or an LP-SS during at least one monitoring occasion, wherein the at least one monitoring occasion corresponds to a collision, in a time domain, between the LP-WUS occasion and the LP-SS occasion. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

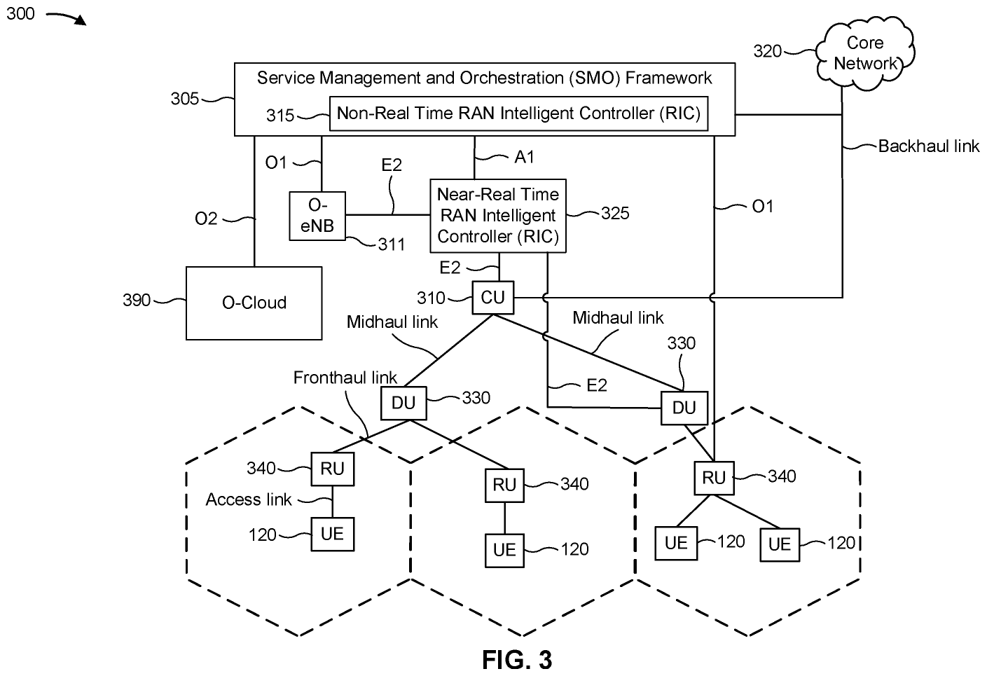

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

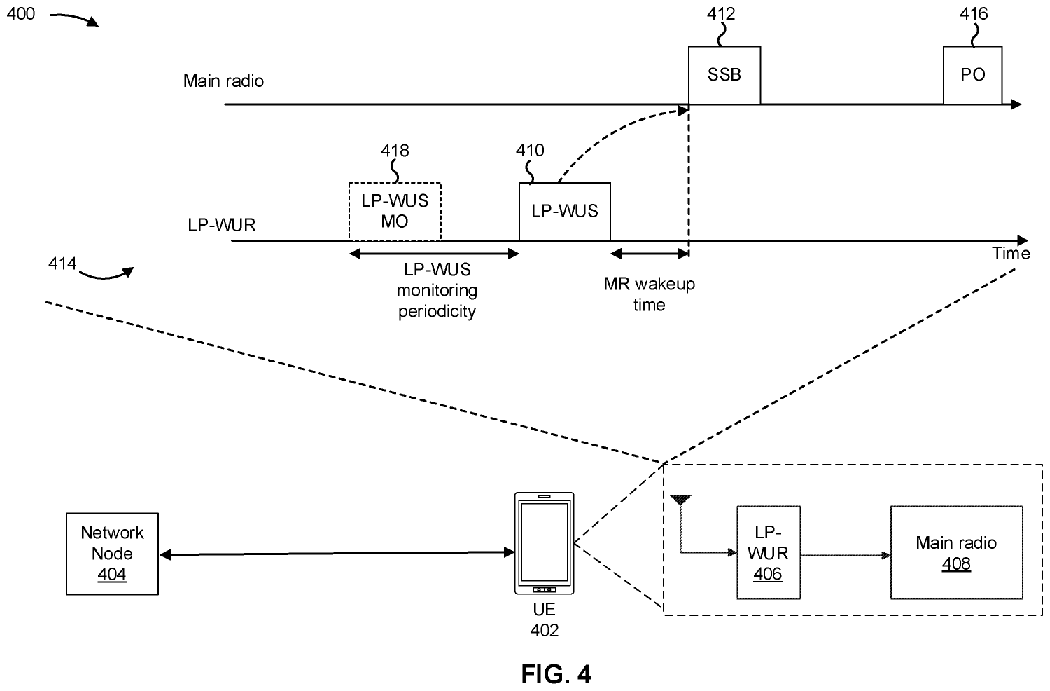

FIG. 4 is a diagram illustrating an example 400 associated with LP-WUR operations, in accordance with the present disclosure. As shown, a UE 402 and a network node 404 may communicate with one another.

The UE 402 includes an LP-WUR 406 and a main radio 408. In some aspects, the LP-WUR 406 and the main radio 408 can each include at least one antenna and one or more integrated electronics, such as an amplifier, an analog-to-digital converter (ADC), a digital to analog converter (DAC), and/or another similar electronic device. In some aspects, the LP-WUR 406 and the main radio 408 can share one or more electronic devices (e.g., an amplifier, a filter, an integrated circuit (IC) configured for FFT or another similar type of operation, and/or another type of IC). The LP-WUR 406 is associated with a lower voltage and/or lower current than the main radio 408. Accordingly, the LP-WUR 406 can be associated with longer battery life for the UE 120 when the LP-WUR 406 is used instead of the main radio 408.

In some cases, the LP-WUR 406 can be configured to detect an LP-WUS 410 and/or an LP-SS but not perform other communications. The LP-WUS 410 can be a signal (e.g., a sequence of bits) configured to wake up the UE 402. The LP-WUS 410 can be configured to specifically wake up a main radio such as the main radio 408. The LP-WUR 406 can have an operating power that does not exceed a threshold that is configured for LP-WURs. The main radio 408 can be configured to perform communications and can have a greater operating power than the LP-WUR 406. When the UE 402 operates the LP-WUR 406 and not the main radio 408, the UE 402 can conserve power in a sleep state and expend less power monitoring for an LP-WUS 410. When the LP-WUS 410 is detected, the UE 402 can wake up the main radio 408, which is able to perform other functions such as monitoring for physical downlink control channel (PDCCH) communications, a synchronization signal block (SSB) 412 and/or other communications, such as data communications. Sleeping may involve turning off a radio and one or more other components or functions of the UE 402. Turning off or switching off a radio may include removing power from the radio such that the radio is not fully operating or operating with full power. Waking up may involve turning on a radio and one or more other components or functions of the UE 402. Turning on or switching on a radio may include adding power to the radio such that the radio is fully operating or operating with full power.

The UE 402 can continuously monitor for an LP-WUS 410 with the LP-WUR 406. In some cases, LP-WUS configurations can be used to reduce unnecessary UE 402 paging receptions. For example, an LP-WUS 410 can be transmitted only if there is paging for idle or inactive mode UEs. As shown by the schematic communication representation 414, if an LP-WUS 410 is detected, the main radio 408 can be turned ON, and the UE 402 can monitor SSB 412 before a paging occasion (PO) 416 for synchronization, and then receive a paging signal accordingly. If an LP-WUS 410 is not detected, the main radio 408 can stay in deep sleep mode for power saving.

In some cases, the LP-WUS 410 can carry a payload (e.g., addressing information) of more than one bit. For example, the LP-WUS 410 can be configured according to a packet-based design in which an LP-WUS packet include a preamble, a payload, and cyclic redundancy check (CRC). The payload can include a cell identifier (ID) for cell identification or UE addressing for paging early indication. In some cases, the LP-WUS 410 can be configured according to a sequence-based design, in which the LP-WUS 410 is formed using a predefined set of sequences dependent on cell ID and UE ID.

Further power efficiencies can be achieved by not keeping the LP-WUR 406 always on for monitoring. For example, an LP-WUR 406 duty cycle mode can be configured. In an LP-WUR 406 duty cycle mode, the UE 402 can turn on the LP-WUR 406 based on a given duty cycle and the network node 404 may only send an LP-WUS 410 within an LP-WUR ON window that includes a set of LP-WUS monitoring occasions 418 for LP-WUS 410. The set of LP-WUS monitoring occasions 418 can be configured with an LP-WUS monitoring periodicity, as shown, that indicates a time difference between the start of one LP-WUS monitoring occasion and the start of the next (in time) LP-WUS monitoring occasion.

In some cases, however, oscillator drift in the UE 402 can lead to a timing mismatch for LP-WUS monitoring. Therefore, an LP-SS can be defined for LP-WUR synchronization. LP-SS can have a longer periodicity than LP-WUS. In some cases, the timing uncertainty arising from the timing drift between LP-SS occasions can be less than one slot. In some cases, for example, the LP-SS can be an electromagnetic signal transmitted by a network (e.g., from a network node 404 that includes, or at least controls, an RU 340) and generated based at least in part on a sequence. For example, the network node 404 can use a Zadoff-Chu sequence, a sequence based on a waveform based on on-off keying (OOK) and/or frequency-shift keying (FSK), or another type of sequence to generate the LP-SS.

In some cases, an LP-SS configuration and an LP-WUS configuration can have different monitoring occasions and different periodicities. In some cases, the monitoring occasions can at least partially overlap in time, causing a collision. Thus, a “collision” can refer to at least a partial overlap, in a time domain, of an LP-WUS occasion and an LP-SS occasion. In some cases, a fixed rule (e.g., drop LP-WUS or drop LP-SS to prioritize LP-WUS) can be used to mitigate collisions. However, dropping the LP-WUS can result in the UE 402 missing paging indication in the LP-WUS, thus increasing paging latency. Dropping the LP-SS can result in the UE 402 receiving nothing since the LP-WUS can have a discontinuous transmission (DTX) configuration that does not transmit LP-WUS on times when there is no paging to be transmitted for the UE. As a result, dropping the LP-SS via a fixed rule can result in out-of-sync failure when multiple LP-SS occasions are dropped.

Some aspects of the techniques and apparatuses described herein may provide a flexible rule for the LP-WUR 406 to manage collisions between LP-SS occasions and LP-WUS occasions. For example, in some aspects, a UE may monitor, using an LP-WUR and based on an LP monitoring configuration, at least one of an LP-WUS occasion or an LP-SS occasion during at least one monitoring occasion. The at least one monitoring occasion may correspond to a collision, in a time domain, between the LP-WUS occasion and the LP-SS occasion. For example, in some aspects, the UE 402 may monitor the at LP-SS occasion and/or the LP-WUS occasion in accordance with priorities associated with the LP-SS occasion and the LP-WUS occasion. The UE 402 may receive the at least one of an LP-WUS or an LP-SS during the at least one monitoring occasion. In this way, some aspects may facilitate operating the LP-WUR according to a duty cycle, while mitigating paging latency and out-of-sync failure due to flexibility in the monitoring configuration. Accordingly, some aspects may positively impact network performance.

As indicated above, FIG. 4 is provided as an example. Other examples may differ from what is described with regard to FIG. 4.

FIG. 5 is a diagram illustrating an example 500 associated with monitoring occasion collision management associated with an LP-WUR, in accordance with the present disclosure. As shown, a UE 502 and a network node 504 may communicate with one another. In some aspects, the UE 502 may be, be similar to, include, or be included in, the UE 402 depicted in FIG. 4 and/or the UE 120 depicted in FIGS. 1-3. In some aspects, the network node 404 may be, be similar to, include, or be included in, the network node 404 depicted in FIG. 4, one or more components of the disaggregated base station architecture 300 depicted in FIG. 3, and/or the network node 110 depicted in FIGS. 1 and 2. The UE 502 may include an LP-WUR and a main radio.

As shown by reference number 506, the UE 502 may transmit, and the network node 504 may receive, UE capability information. The UE capability information may indicate at least one capability of the UE 502 for supporting a LP monitoring configuration. In some aspects, the UE capability information may indicate UE capabilities associated with one or more aspects of an LP monitoring configuration.

As shown by reference number 508, the network node 504 may transmit, and the UE 502 may receive, configuration information. The configuration information may indicate an LP monitoring configuration. In some aspects, the LP monitoring configuration may indicate a first monitoring priority associated with one or more LP-WUS occasions and a second monitoring priority associated with one or more LP-SS occasions. In some aspects, the first monitoring priority may be higher than the second monitoring priority.

In some aspects, the LP monitoring configuration may indicate a prioritization timer. A prioritization (e.g., a relationship between priorities) associated with the first monitoring priority and the second monitoring priority may be based on the prioritization timer. In some aspects, the LP monitoring configuration may indicate an initial value of the prioritization timer. For example, in some aspects, the initial value of the prioritization timer may correspond to one or more LP-SS periodicity values. In some aspects, the LP monitoring configuration may indicate an LP-WUS configuration for synchronization of the UE 502 with the network node 504. In some aspects, the UE 502 may start the prioritization timer based on receiving a first LP-WUS.

In some aspects, a prioritization associated with the first monitoring priority and the second monitoring priority may be based on the at least one UE capability reported in the UE capability information. For example, in some aspects, the at least one capability may include a capability for supporting simultaneous reception, using the LP-WUR, of the LP-SS and the LP-WUS, and the first monitoring priority may be equal to the second monitoring priority based on the at least one capability. In some aspects, for example, if the UE 502 supports multiple reception using the LP-WUR, the UE 502 may simultaneously receive both LP-SS and LP-WUS, but with different reception antennas. Therefore, the UE 502 may report its capability for simultaneous reception of LP-SS and LP-WUS using different reception antennas.

In some aspects, the LP monitoring configuration may include a radio resource management (RRM) measurement configuration associated with the LP-WUS. In some aspects, the LP monitoring configuration may indicate a power ratio associated with the LP-WUS and the LP-SS. The power ratio between LP-SS and LP-WUS may facilitate combination, by the UE 502, of measurement results based on LP-SS and LP-WUS.

As shown by reference number 510, the UE 502 may monitor using the LP-WUR. For example, the UE 502 may monitor at least one of an LP-WUS occasion or an LP-SS occasion based on the LP monitoring configuration and during at least one monitoring occasion. The at least one monitoring occasion may correspond to a collision, in a time domain, between the LP-WUS occasion and the LP-SS occasion.

In some aspects, the at least one monitoring occasion may correspond to the collision based on a relationship between a switching time and a starting time of the LP-WUS occasion. For example, the switching time may include a quantity of symbols, and the at least one monitoring occasion may correspond to the collision based on the starting time of the LP-WUS occasion occurring within a first time period or a second time period, where the first time period includes the quantity of symbols and ends with an ending symbol that is adjacent, in the time domain, to a starting symbol of the LP-SS occasion, and where the second time period includes the quantity of symbols and starts with a starting symbol adjacent, in the time domain, to an ending symbol of the LP-SS occasion.

In some aspects, the switching time may be fixed. In some other aspects, the switching time may be based on UE capability information that indicates the switching time. For example, the collision between the LP-SS occasion and the LP-WUS occasion may be managed based on the potential switching time if LP-SS and LP-WUS are configured with non-overlapping frequency resources. For example, if the switching time is Nr symbols, the LP-WUS occasion may be determined to be overlapping with the LP-SS occasion if it starts less than Nr symbols before the first symbol of the LP-SS occasion or ends within Nr symbols after the last symbol of LP-SS occasion.

As shown by reference number 512, the network node 504 may transmit, and the UE 502 may receive, at least one of an LP-SS or an LP-WUS during the monitoring occasion. As shown by reference number 514, the UE 502 may wake up the main radio based on receiving the at least one of the LP-SS or the LP-WUS. In some aspects, the at least one capability may include a capability for supporting activation of a non-LP radio (e.g., a main radio) based on a collision between the LP-WUS occasion and the LP-SS occasion. In some aspects, the activation of the non-LP radio may include activation of the non-LP radio to monitor at least one of an SSB occasion, a PDCCH-based paging early indicator occasion, or a paging PDCCH occasion.

In some aspects, receiving the at least one of the LP-WUS or the LP-SS may include receiving the LP-WUS and the LP-SS. In this case, the UE 502 may obtain a first RRM measurement associated with the LP-WUS and a second RRM measurement associated with the LP-SS. The UE 502 may generate, based on a configured power ratio, an RRM measurement result based on a combination of the first RRM measurement and the second RRM measurement.

As shown by reference number 516, the network node 504 may transmit, and the UE 502 may receive, a go-to-sleep (GTS) indication. The GTS indication may indicate to the UE 502 that the UE 502 is to transition the LP-WUR to a sleep state. Accordingly, as shown by reference number 518, the UE 502 may transition the LP-WUR to a sleep state based on receiving the GTS indication.

As indicated above, FIG. 5 is provided as an example. Other examples may differ from what is described with regard to FIG. 5.

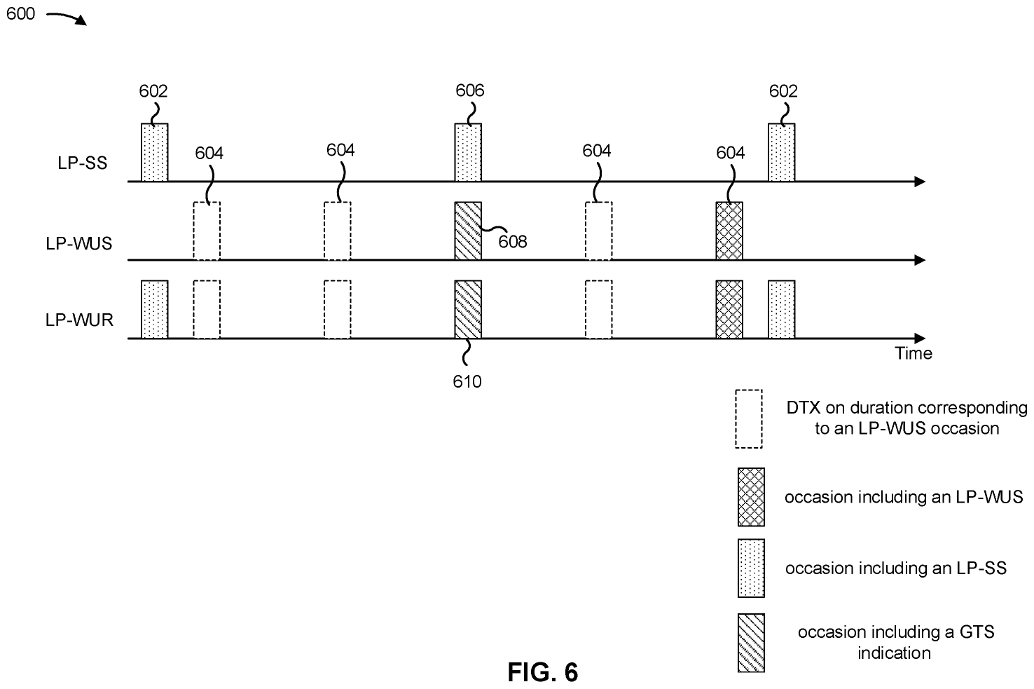

FIG. 6 is a diagram illustrating an example 600 associated with monitoring occasion collision management associated with an LP-WUR, in accordance with the present disclosure. Example 600 includes a schematic communication representation indicating relative timing between LP-SS occasions 602, LP-WUS occasions 604, and LP-WUR monitoring behavior.

For example, in some aspects, the LP monitoring configuration may indicate a first monitoring priority associated with the LP-WUS occasions 604 and a second monitoring priority associated with the LP-SS occasions 602. In example 600, the first monitoring priority is higher than the second monitoring priority. For example, a UE (e.g., the UE 502) may prioritize LP-WUS occasions 604 over LP-SS occasions 602. For example, as shown, an LP-SS occasion 606 may collide with an LP-WUS occasion 608. Accordingly, the UE may monitor, in a monitoring occasion 610, the LP-WUS occasion 608. In some aspects, if there is no paging indication being transmitted for the UE during the LP-WUS occasion 608, the network node (e.g., the network node 504) may transmit a GTS indication.

For example, in some aspects, LP-WUS without DTX may be assumed for an LP-WUS occasion overlapping with an LP-SS occasion. LP-WUS with DTX may still be assumed for other occasions not overlapping with LP-SS. The GTS indication may be used by the LP-WUR to maintain synchronization with the network node. The GTS indication may be transmitted using the same format as an LP-WUS, thereby avoiding increasing signal processing complexity in introducing the GTS indication.

As indicated above, FIG. 6 is provided as an example. Other examples may differ from what is described with regard to FIG. 6.

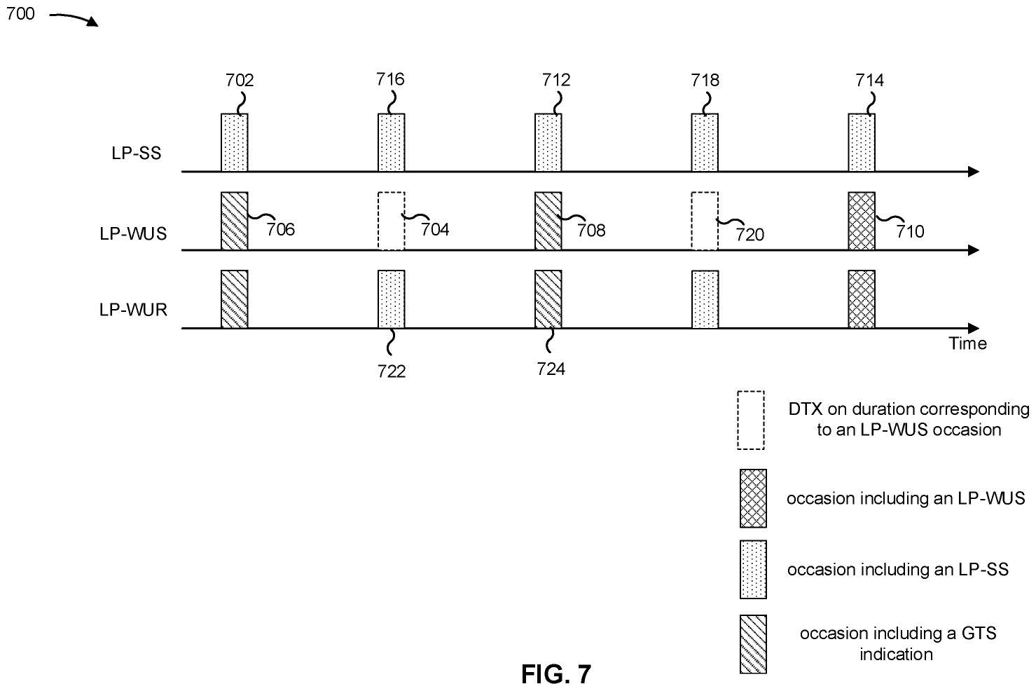

FIG. 7 is a diagram illustrating an example 700 associated with monitoring occasion collision management associated with an LP-WUR, in accordance with the present disclosure. Example 700 includes a schematic communication representation indicating relative timing between LP-SS occasions 702, LP-WUS occasions 704, and LP-WUR monitoring behavior.

In example 700, a UE (e.g., the UE 502) may prioritize LP-WUS occasions 704 over LP-SS occasions 702 based on a configured minimum GTS periodicity. For example, the transmission of the GTS indication may be configured with a minimum periodicity, e.g., N overlapping cycles instead of every overlapping occasion with LP-SS. For example, a GTS indication may be transmitted in an LP-WUS occasion 706 and an LP-WUS occasion 708. As an example, the GTS indication may be configured to be transmitted at a minimum of two LP-SS periodicities when there is no paging indication for the UE, as shown. The LP-WUS occasions 706, 708, and 710 may be prioritized over the LP-SS occasions 702, 712, and 714, while the LP-SS occasions 716 and 718 may be prioritized over the LP-WUS occasions 704 and 720. For example, at a monitoring occasion 722, the UE may wake up and monitor the LP-SS occasion 716 and at a monitoring occasion 724 the UE may monitor the LP-WUS occasion 708.

As indicated above, FIG. 7 is provided as an example. Other examples may differ from what is described with regard to FIG. 7.

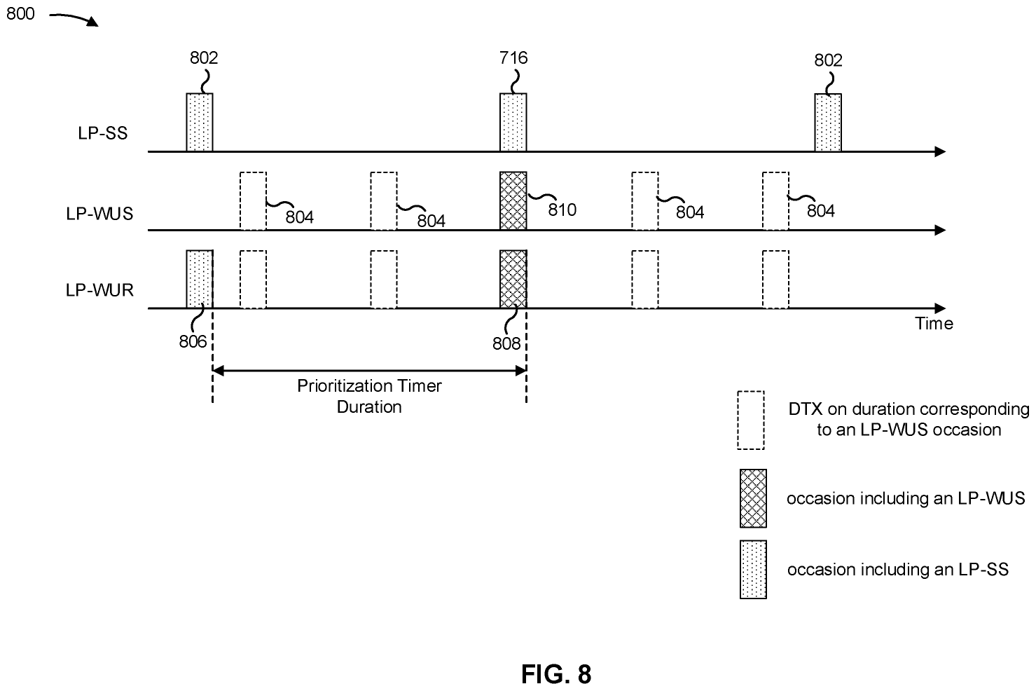

FIG. 8 is a diagram illustrating an example 800 associated with monitoring occasion collision management associated with an LP-WUR, in accordance with the present disclosure. Example 800 includes a schematic communication representation indicating relative timing between LP-SS occasions 802, LP-WUS occasions 804, and LP-WUR monitoring behavior.

In example 800, a UE (e.g., the UE 502) may be configured with a prioritization timer. A prioritization associated with a first monitoring priority (e.g., associated with LP-WUS occasions 804) and a second monitoring priority (e.g., associated with LP-SS occasions 802) may be based on the prioritization timer. The prioritization timer may be started (or restarted) every time the LP-WUR receives an LP-SS. While the timer runs, LP-WUS occasions 804 may be prioritized over LP-SS occasions 802, and when the timer expires, LP-SS occasions 802 may be prioritized over LP-WUS occasions 804. As shown, for example, during a monitoring occasion 806, the UE may receive an LP-SS. The UE may start the prioritization timer based on receiving the LP-SS. Thus, a monitoring occasion 808 may fall within the prioritization timer duration and the UE may monitor the LP-WUS occasion 810.

In some aspects, the initial value of the timer may be configured as one (as shown in FIG. 8) or multiple LP-SS periodicities. In some aspects, if LP-WUS is configured to provide synchronization for LP-WUR, the timer may be started or restarted after receiving an LP-WUS.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 502) performs operations associated with monitoring occasion collision management associated with an LP-WUR.

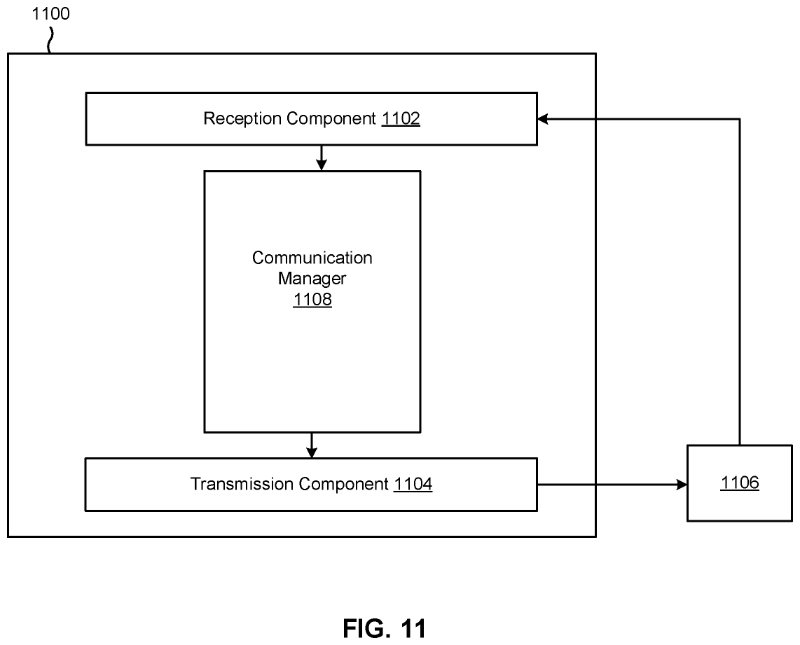

As shown in FIG. 9, in some aspects, process 900 may include monitoring, using an LP-WUR and based on an LP monitoring configuration, at least one of an LP-WUS occasion or an LP-SS occasion during at least one monitoring occasion, wherein the at least one monitoring occasion corresponds to a collision, in a time domain, between the LP-WUS occasion and the LP-SS occasion (block 910). For example, the UE (e.g., using communication manager 1108 and/or reception component 1102, depicted in FIG. 11) may monitor, using an LP-WUR and based on an LP monitoring configuration, at least one of an LP-WUS occasion or an LP-SS occasion during at least one monitoring occasion, wherein the at least one monitoring occasion corresponds to a collision, in a time domain, between the LP-WUS occasion and the LP-SS occasion, as described above.

As further shown in FIG. 9, in some aspects, process 900 may include receiving the at least one of an LP-WUS or an LP-SS during the at least one monitoring occasion (block 920). For example, the UE (e.g., using communication manager 1108 and/or reception component 1102, depicted in FIG. 11) may receive the at least one of an LP-WUS or an LP-SS during the at least one monitoring occasion, as described above.

Process 900 may include additional aspects, such as any single aspect or any combination of aspects described below and/or in connection with one or more other processes described elsewhere herein.

In a first aspect, the LP monitoring configuration indicates a first monitoring priority associated with the LP-WUS occasion and a second monitoring priority associated with the LP-SS occasion. In a second aspect, alone or in combination with the first aspect, the first monitoring priority is higher than the second monitoring priority. In a third aspect, alone or in combination with one or more of the first and second aspects, the LP monitoring configuration indicates a prioritization timer, wherein a prioritization associated with the first monitoring priority and the second monitoring priority is based on the prioritization timer. In a fourth aspect, alone or in combination with the third aspect, process 900 includes receiving, during a prior monitoring occasion occurring before the at least one monitoring occasion, a first LP-SS, and starting the prioritization timer based on receiving the first LP-SS, wherein the first monitoring priority is higher than the second monitoring priority based on the at least one monitoring occasion occurring prior to expiration of the prioritization timer.

In a fifth aspect, alone or in combination with one or more of the third or fourth aspects, the LP monitoring configuration indicates an initial value of the prioritization timer. In a sixth aspect, alone or in combination with the fifth aspect, the initial value of the prioritization timer corresponds to one or more LP-SS periodicity values. In a seventh aspect, alone or in combination with the third aspect, the LP monitoring configuration indicates an LP-WUS configuration for synchronization of the UE with a network node, and process 900 includes starting the prioritization timer based on receiving a first LP-WUS.

In an eighth aspect, alone or in combination with one or more of the first through seventh aspects, process 900 includes transmitting UE capability information that indicates at least one capability of the UE for supporting an LP monitoring configuration, wherein a prioritization associated with the first monitoring priority and the second monitoring priority is based on the at least one capability. In a ninth aspect, alone or in combination with the eighth aspect, the at least one capability comprises a capability for supporting simultaneous reception, using the LP-WUR, of the LP-SS and the LP-WUS, and the first monitoring priority is equal to the second monitoring priority based on the at least one capability. In a tenth aspect, alone or in combination with one or more of the eighth or ninth aspects, the at least one capability comprises a capability for supporting activation of a non-LP radio based on a collision between the LP-WUS occasion and the LP-SS occasion, wherein the activation of the non-LP radio comprises activation of the non-LP radio to monitor at least one of a synchronization signal block occasion, a PDCCH-based paging early indicator occasion, or a paging PDCCH occasion.

In an eleventh aspect, alone or in combination with one or more of the first through tenth aspects, process 900 includes receiving a GTS indication associated with the at least one monitoring occasion based on the at least one monitoring occasion corresponding to the collision between the LP-WUS occasion and the LP-SS occasion, and transitioning the LP-WUR to a sleep state based on receiving the GTS indication. In a twelfth aspect, alone or in combination with the eleventh aspect, the LP-WUS occasion comprises a DTX occasion corresponding to a DTX configuration associated with transmitting one or more LP-WUSs, including the LP-WUS. In a thirteenth aspect, alone or in combination with the twelfth aspect, the DTX configuration corresponds to at least one additional monitoring occasion associated with an additional LP-WUS occasion that does not collide, in the time domain, with any LP-SS occasion.

In a fourteenth aspect, alone or in combination with one or more of the eleventh through thirteenth aspects, the GTS indication is based on no paging indication being transmitted during the LP-WUS occasion. In a fifteenth aspect, alone or in combination with one or more of the eleventh through fourteenth aspects, receiving the GTS indication comprises receiving a GTS signal having a format corresponding to a format configured for transmission of the LP-WUS. In a sixteenth aspect, alone or in combination with one or more of the eleventh through fifteenth aspects, the GTS indication corresponds to a GTS configuration associated with a first periodicity, and the LP-SS occasion corresponds to an LP-SS configuration associated with a second periodicity that is greater than the first periodicity.

In a seventeenth aspect, alone or in combination with one or more of the first through sixteenth aspects, the LP monitoring configuration comprises an RRM measurement configuration associated with the LP-WUS. In an eighteenth aspect, alone or in combination with the seventeenth aspect, the LP monitoring configuration indicates a power ratio associated with the LP-WUS and the LP-SS. In a nineteenth aspect, alone or in combination with the eighteenth aspect, receiving the at least one of the LP-WUS or the LP-SS comprises receiving the LP-WUS and the LP-SS, and process 900 includes obtaining a first RRM measurement associated with the LP-WUS, obtaining a second RRM measurement associated with the LP-SS, and generating, based on the power ratio, an RRM measurement result based on a combination of the first RRM measurement and the second RRM measurement.

In a twentieth aspect, alone or in combination with one or more of the first through nineteenth aspects, the at least one monitoring occasion corresponds to the collision based on a relationship between a switching time and a starting time of the LP-WUS occasion. In a twenty-first aspect, alone or in combination with the twentieth aspect, the switching time comprises a quantity of symbols, and the at least one monitoring occasion corresponds to the collision based on the starting time of the LP-WUS occasion occurring within a first time period or a second time period, wherein the first time period comprises the quantity of symbols and ends with an ending symbol that is adjacent, in the time domain, to a starting symbol of the LP-SS occasion, and the second time period comprises the quantity of symbols and starts with a starting symbol adjacent, in the time domain, to an ending symbol of the LP-SS occasion.

In a twenty-second aspect, alone or in combination with one or more of the twentieth or twenty-first aspects, the switching time is fixed. In a twenty-third aspect, alone or in combination with one or more of the twentieth through twenty-second aspects, process 900 includes transmitting UE capability information that indicates the switching time.

In a twenty-fourth aspect, alone or in combination with one or more of the first through twenty-third aspects, process 900 includes receiving configuration information that indicates the LP monitoring configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 504) performs operations associated with monitoring occasion collision management associated with an LP-WUR.

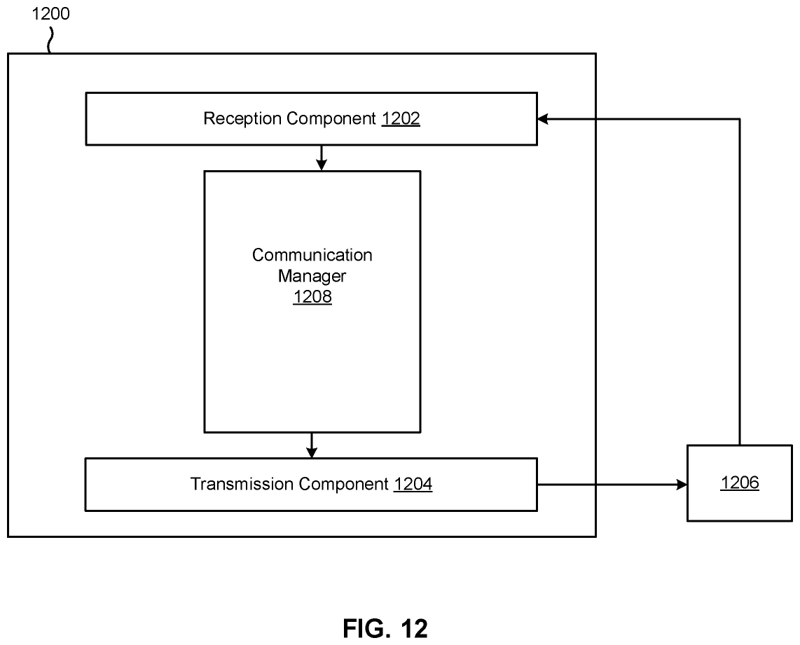

As shown in FIG. 10, in some aspects, process 1000 may include transmitting, to a UE comprising an LP-WUR, configuration information indicative of an LP monitoring configuration corresponding to a monitoring operation associated with at least one of an LP-WUS occasion or an LP-SS occasion (block 1010). For example, the network node (e.g., using communication manager 1208 and/or transmission component 1204, depicted in FIG. 12) may transmit, to a UE an LP-WUR, configuration information indicative of an LP monitoring configuration corresponding to a monitoring operation associated with at least one of an LP-WUS occasion or an LP-SS occasion, as described above.

As further shown in FIG. 10, in some aspects, process 1000 may include transmitting at least one of an LP-WUS or an LP-SS during at least one monitoring occasion, wherein the at least one monitoring occasion corresponds to a collision, in a time domain, between the LP-WUS occasion and the LP-SS occasion (block 1020). For example, the network node (e.g., using communication manager 1208 and/or transmission component 1204, depicted in FIG. 12) may transmit at least one of an LP-WUS or an LP-SS during at least one monitoring occasion, wherein the at least one monitoring occasion corresponds to a collision, in a time domain, between the LP-WUS occasion and the LP-SS occasion, as described above.

Process 1000 may include additional aspects, such as any single aspect or any combination of aspects described below and/or in connection with one or more other processes described elsewhere herein.

In a first aspect, the LP monitoring configuration indicates a first monitoring priority associated with the LP-WUS occasion and a second monitoring priority associated with the LP-SS occasion. In a second aspect, alone or in combination with the first aspect, the first monitoring priority is higher than the second monitoring priority. In a third aspect, alone or in combination with one or more of the first and second aspects, the LP monitoring configuration indicates a prioritization timer, wherein a prioritization associated with the first monitoring priority and the second monitoring priority is based on the prioritization timer. In a fourth aspect, alone or in combination the third aspect, process 1000 includes transmitting, during a prior monitoring occasion occurring before the at least one monitoring occasion, a first LP-SS, wherein a start of the prioritization timer is based on the first LP-SS, wherein the first monitoring priority is higher than the second monitoring priority based on the at least one monitoring occasion occurring prior to expiration of the prioritization timer. In a fifth aspect, alone or in combination with one or more of the third or fourth aspects, the LP monitoring configuration indicates an initial value of the prioritization timer. In a sixth aspect, alone or in combination with the fifth aspect, the initial value of the prioritization timer corresponds to one or more LP-SS periodicity values. In a seventh aspect, alone or in combination with one or more of the third through sixth aspects, the LP monitoring configuration indicates an LP-WUS configuration for synchronization of the UE with a network node, and a start of the prioritization timer is based on a first LP-WUS.

In an eighth aspect, alone or in combination with one or more of the first through seventh aspects, process 1000 includes receiving UE capability information that indicates at least one capability of the UE for supporting an LP monitoring configuration, wherein a prioritization associated with the first monitoring priority and the second monitoring priority is based on the at least one capability. In a ninth aspect, alone or in combination with the eighth aspect, the at least one capability comprises a capability for supporting simultaneous reception, using the LP-WUR, of the LP-SS and the LP-WUS, and the first monitoring priority is equal to the second monitoring priority based on the at least one capability. In a tenth aspect, alone or in combination with one or more of the eighth or ninth aspects, the at least one capability comprises a capability for supporting activation of a non-LP radio based on a collision between the LP-WUS occasion and the LP-SS occasion, wherein the activation of the non-LP radio comprises activation of the non-LP radio to monitor at least one of a synchronization signal block occasion, a PDCCH-based paging early indicator occasion, or a paging PDCCH occasion.

In an eleventh aspect, alone or in combination with one or more of the first through tenth aspects, process 1000 includes transmitting a GTS indication associated with the at least one monitoring occasion based on the at least one monitoring occasion corresponding to the collision between the LP-WUS occasion and the LP-SS occasion. In a twelfth aspect, alone or in combination with the eleventh aspect, the LP-WUS occasion comprises a DTX occasion corresponding to a DTX configuration associated with transmitting one or more LP-WUSs, including the LP-WUS. In a thirteenth aspect, alone or in combination with the twelfth aspect, the DTX configuration corresponds to at least one additional monitoring occasion associated with an additional LP-WUS occasion that does not collide, in the time domain, with any LP-SS occasion.

In a fourteenth aspect, alone or in combination with one or more of the eleventh through thirteenth aspects, the GTS indication is based on no paging indication being transmitted during the LP-WUS occasion. In a fifteenth aspect, alone or in combination with one or more of the eleventh through fourteenth aspects, receiving the GTS indication comprises receiving a GTS signal having a format corresponding to a format configured for transmission of the LP-WUS. In a sixteenth aspect, alone or in combination with one or more of the eleventh through fifteenth aspects, the GTS indication corresponds to a GTS configuration associated with a first periodicity, and the LP-SS occasion corresponds to an LP-SS configuration associated with a second periodicity that is greater than the first periodicity.

In a seventeenth aspect, alone or in combination with one or more of the first through sixteenth aspects, the LP monitoring configuration comprises an RRM measurement configuration associated with the LP-WUS. In an eighteenth aspect, alone or in combination with one or more of the first through seventeenth aspects, the LP monitoring configuration indicates a power ratio associated with the LP-WUS and the LP-SS. In a nineteenth aspect, alone or in combination with the eighteenth aspect, transmitting the at least one of the LP-WUS or the LP-SS comprises transmitting the LP-WUS and the LP-SS.

In a twentieth aspect, alone or in combination with one or more of the first through nineteenth aspects, the at least one monitoring occasion corresponds to the collision based on a relationship between a switching time and a starting time of the LP-WUS occasion. In a twenty-first aspect, alone or in combination with the twentieth aspect, the switching time comprises a quantity of symbols, and the at least one monitoring occasion corresponds to the collision based on the starting time of the LP-WUS occasion occurring within a first time period or a second time period, wherein the first time period comprises the quantity of symbols and ends with an ending symbol that is adjacent, in the time domain, to a starting symbol of the LP-SS occasion, and the second time period comprises the quantity of symbols and starts with a starting symbol adjacent, in the time domain, to an ending symbol of the LP-SS occasion. In a twenty-second aspect, alone or in combination with one or more of the twentieth or twenty-first aspects, the switching time is fixed. In a twenty-third aspect, alone or in combination with one or more of the twentieth through twenty-second aspects, process 1000 includes receiving UE capability information that indicates the switching time.

In a twenty-fourth aspect, alone or in combination with one or more of the first through twenty-third aspects, process 1000 includes transmitting configuration information that indicates the LP monitoring configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1108 and/or the reception component 1102 may monitor, using an LP-WUR and based on an LP monitoring configuration, at least one of an LP-WUS occasion or an LP-SS occasion during at least one monitoring occasion, wherein the at least one monitoring occasion corresponds to a collision, in a time domain, between the LP-WUS occasion and the LP-SS occasion. In some aspects, the communication manager 1108 may include one or more antennas, a modem, a controller/processor, a memory, or a combination thereof, of the UE described in connection with FIG. 2. In some aspects, the communication manager 1108 may include the reception component 1102 and/or the transmission component 1104. In some aspects, the communication manager 1108 may be, be similar to, include, or be included in, the communication manager 140 depicted in FIGS. 1 and 2.

The communication manager 1108 and/or the reception component 1102 may receive the at least one of an LP-WUS or an LP-SS during the at least one monitoring occasion. The communication manager 1108 and/or the reception component 1102 may receive, during a prior monitoring occasion occurring before the at least one monitoring occasion, a first LP-SS. The communication manager 1108 may start the prioritization timer based on receiving the first LP-SS, wherein the first monitoring priority is higher than the second monitoring priority based on the at least one monitoring occasion occurring prior to expiration of the prioritization timer.

The communication manager 1108 and/or the transmission component 1104 may transmit UE capability information that indicates at least one capability of the UE for supporting an LP monitoring configuration, wherein a prioritization associated with the first monitoring priority and the second monitoring priority is based on the at least one capability.

The communication manager 1108 and/or the reception component 1102 may receive a GTS indication associated with the at least one monitoring occasion based on the at least one monitoring occasion corresponding to the collision between the LP-WUS occasion and the LP-SS occasion. The communication manager 1108 may transition the LP-WUR to a sleep state based on receiving the GTS indication.

The communication manager 1108 and/or the transmission component 1104 may transmit UE capability information that indicates the switching time. The communication manager 1108 and/or the reception component 1102 may receive configuration information that indicates the LP monitoring configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208.

In some aspects, the apparatus 1200 may be configured to perform one or more operations described herein in connection with FIGS. 5-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1208 and/or the transmission component 1204 may transmit, to a UE comprising an LP-WUR, configuration information indicative of an LP monitoring configuration corresponding to a monitoring operation associated with at least one of an LP-WUS occasion or an LP-SS occasion. In some aspects, the communication manager 1208 may include one or more antennas, a modem, a controller/processor, a memory, or a combination thereof, of the network node described in connection with FIG. 2. In some aspects, the communication manager 1208 may include the reception component 1202 and/or the transmission component 1204. In some aspects, the communication manager 1208 may be, be similar to, include, or be included in, the communication manager 150 depicted in FIGS. 1 and 2.

The communication manager 1208 and/or the transmission component 1204 may transmit at least one of an LP-WUS or an LP-SS during at least one monitoring occasion, wherein the at least one monitoring occasion corresponds to a collision, in a time domain, between the LP-WUS occasion and the LP-SS occasion. The communication manager 1208 and/or the transmission component 1204 may transmit, during a prior monitoring occasion occurring before the at least one monitoring occasion, a first LP-SS, wherein a start of the prioritization timer is based on the first LP-SS, wherein the first monitoring priority is higher than the second monitoring priority based on the at least one monitoring occasion occurring prior to expiration of the prioritization timer. The communication manager 1208 and/or the reception component 1202 may receive UE capability information that indicates at least one capability of the UE for supporting an LP monitoring configuration, wherein a prioritization associated with the first monitoring priority and the second monitoring priority is based on the at least one capability.

The communication manager 1208 and/or the transmission component 1204 may transmit a GTS indication associated with the at least one monitoring occasion based on the at least one monitoring occasion corresponding to the collision between the LP-WUS occasion and the LP-SS occasion.

The communication manager 1208 and/or the reception component 1202 may receive UE capability information that indicates the switching time. The communication manager 1208 and/or the transmission component 1204 may transmit configuration information that indicates the LP monitoring configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: monitoring, using a low-power (LP) wake-up-radio (LP-WUR) and based on an LP monitoring configuration, at least one of an LP-wake-up-signal (LP-WUS) occasion or an LP-synchronization-signal (LP-SS) occasion during at least one monitoring occasion, wherein the at least one monitoring occasion corresponds to a collision, in a time domain, between the LP-WUS occasion and the LP-SS occasion; and receiving the at least one of an LP-WUS or an LP-SS during the at least one monitoring occasion.

Aspect 2: The method of Aspect 1, wherein the LP monitoring configuration indicates a first monitoring priority associated with the LP-WUS occasion and a second monitoring priority associated with the LP-SS occasion.

Aspect 3: The method of Aspect 2, wherein the first monitoring priority is higher than the second monitoring priority.

Aspect 4: The method of either of Aspects 2 or 3, wherein the LP monitoring configuration indicates a prioritization timer, wherein a prioritization associated with the first monitoring priority and the second monitoring priority is based on the prioritization timer.

Aspect 5: The method of Aspect 4, further comprising: receiving, during a prior monitoring occasion occurring before the at least one monitoring occasion, a first LP-SS; and starting the prioritization timer based on receiving the first LP-SS, wherein the first monitoring priority is higher than the second monitoring priority based on the at least one monitoring occasion occurring prior to expiration of the prioritization timer.

Aspect 6: The method of either of Aspects 4 or 5, wherein the LP monitoring configuration indicates an initial value of the prioritization timer.

Aspect 7: The method of Aspect 6, wherein the initial value of the prioritization timer corresponds to one or more LP-SS periodicity values.

Aspect 8: The method of Aspect 4, wherein the LP monitoring configuration indicates an LP-WUS configuration for synchronization of the UE with a network node, the method further comprising starting the prioritization timer based on receiving a first LP-WUS.

Aspect 9: The method of any of Aspects 2-8, further comprising transmitting UE capability information that indicates at least one capability of the UE for supporting an LP monitoring configuration, wherein a prioritization associated with the first monitoring priority and the second monitoring priority is based on the at least one capability.

Aspect 10: The method of Aspect 9, wherein the at least one capability comprises a capability for supporting simultaneous reception, using the LP-WUR, of the LP-SS and the LP-WUS, and wherein the first monitoring priority is equal to the second monitoring priority based on the at least one capability.

Aspect 11: The method of either of Aspects 9 or 10, wherein the at least one capability comprises a capability for supporting activation of a non-LP radio based on a collision between the LP-WUS occasion and the LP-SS occasion, wherein the activation of the non-LP radio comprises activation of the non-LP radio to monitor at least one of a synchronization signal block occasion, a physical downlink control channel (PDCCH)-based paging early indicator occasion, or a paging PDCCH occasion.

Aspect 12: The method of any of Aspects 1-11, further comprising: receiving a go-to-sleep (GTS) indication associated with the at least one monitoring occasion based on the at least one monitoring occasion corresponding to the collision between the LP-WUS occasion and the LP-SS occasion; and transitioning the LP-WUR to a sleep state based on receiving the GTS indication.

Aspect 13: The method of Aspect 12, wherein the LP-WUS occasion comprises a discontinuous transmission (DTX) occasion corresponding to a DTX configuration associated with transmitting one or more LP-WUSs, including the LP-WUS.

Aspect 14: The method of Aspect 13, wherein the DTX configuration corresponds to at least one additional monitoring occasion associated with an additional LP-WUS occasion that does not collide, in the time domain, with any LP-SS occasion.

Aspect 15: The method of any of Aspects 12-14, wherein the GTS indication is based on no paging indication being transmitted during the LP-WUS occasion.

Aspect 16: The method of any of Aspects 12-15, wherein receiving the GTS indication comprises receiving a GTS signal having a format corresponding to a format configured for transmission of the LP-WUS.

Aspect 17: The method of any of Aspects 12-16, wherein the GTS indication corresponds to a GTS configuration associated with a first periodicity, and wherein the LP-SS occasion corresponds to an LP-SS configuration associated with a second periodicity that is greater than the first periodicity.

Aspect 18: The method of any of Aspects 1-17, wherein the LP monitoring configuration comprises a radio resource management (RRM) measurement configuration associated with the LP-WUS.

Aspect 19: The method of Aspect 18, wherein the LP monitoring configuration indicates a power ratio associated with the LP-WUS and the LP-SS.

Aspect 20: The method of Aspect 19, wherein receiving the at least one of the LP-WUS or the LP-SS comprises receiving the LP-WUS and the LP-SS, the method further comprising: obtaining a first RRM measurement associated with the LP-WUS; obtaining a second RRM measurement associated with the LP-SS; and generating, based on the power ratio, an RRM measurement result based on a combination of the first RRM measurement and the second RRM measurement.

Aspect 21: The method of any of Aspects 1-20, wherein the at least one monitoring occasion corresponds to the collision based on a relationship between a switching time and a starting time of the LP-WUS occasion.

Aspect 22: The method of Aspect 21, wherein the switching time comprises a quantity of symbols, and wherein the at least one monitoring occasion corresponds to the collision based on the starting time of the LP-WUS occasion occurring within a first time period or a second time period, wherein the first time period comprises the quantity of symbols and ends with an ending symbol that is adjacent, in the time domain, to a starting symbol of the LP-SS occasion, and wherein the second time period comprises the quantity of symbols and starts with a starting symbol adjacent, in the time domain, to an ending symbol of the LP-SS occasion.

Aspect 23: The method of either of Aspects 21 or 22, wherein the switching time is fixed.

Aspect 24: The method of any of Aspects 21-23, further comprising transmitting UE capability information that indicates the switching time.

Aspect 25: The method of any of Aspects 1-24, further comprising receiving configuration information that indicates the LP monitoring configuration.

Aspect 26: A method of wireless communication performed by a network node, comprising: transmitting, to a user equipment (UE) comprising a low-power (LP) wake-up-radio (LP-WUR), configuration information indicative of an LP monitoring configuration corresponding to a monitoring operation associated with at least one of an LP-wake-up-signal (LP-WUS) occasion or an LP-synchronization-signal (LP-SS) occasion; and transmitting at least one of an LP-WUS or an LP-SS during at least one monitoring occasion, wherein the at least one monitoring occasion corresponds to a collision, in a time domain, between the LP-WUS occasion and the LP-SS occasion.

Aspect 27: The method of Aspect 26, wherein the LP monitoring configuration indicates a first monitoring priority associated with the LP-WUS occasion and a second monitoring priority associated with the LP-SS occasion.

Aspect 28: The method of Aspect 27, wherein the first monitoring priority is higher than the second monitoring priority.

Aspect 29: The method of either of Aspects 27 or 28, wherein the LP monitoring configuration indicates a prioritization timer, wherein a prioritization associated with the first monitoring priority and the second monitoring priority is based on the prioritization timer.

Aspect 30: The method of Aspect 29, further comprising transmitting, during a prior monitoring occasion occurring before the at least one monitoring occasion, a first LP-SS, wherein a start of the prioritization timer is based on the first LP-SS, wherein the first monitoring priority is higher than the second monitoring priority based on the at least one monitoring occasion occurring prior to expiration of the prioritization timer.

Aspect 31: The method of either of Aspects 29 or 30, wherein the LP monitoring configuration indicates an initial value of the prioritization timer.

Aspect 32: The method of Aspect 31, wherein the initial value of the prioritization timer corresponds to one or more LP-SS periodicity values.

Aspect 33: The method of any of Aspects 29-32, wherein the LP monitoring configuration indicates an LP-WUS configuration for synchronization of the UE with a network node, and wherein a start of the prioritization timer is based on a first LP-WUS.

Aspect 34: The method of any of Aspects 27-33, further comprising receiving UE capability information that indicates at least one capability of the UE for supporting an LP monitoring configuration, wherein a prioritization associated with the first monitoring priority and the second monitoring priority is based on the at least one capability.

Aspect 35: The method of Aspect 34, wherein the at least one capability comprises a capability for supporting simultaneous reception, using the LP-WUR, of the LP-SS and the LP-WUS, and wherein the first monitoring priority is equal to the second monitoring priority based on the at least one capability.

Aspect 36: The method of either of Aspects 34 or 35, wherein the at least one capability comprises a capability for supporting activation of a non-LP radio based on a collision between the LP-WUS occasion and the LP-SS occasion, wherein the activation of the non-LP radio comprises activation of the non-LP radio to monitor at least one of a synchronization signal block occasion, a physical downlink control channel (PDCCH)-based paging early indicator occasion, or a paging PDCCH occasion.

Aspect 37: The method of any of Aspects 26-36, further comprising transmitting a go-to-sleep (GTS) indication associated with the at least one monitoring occasion based on the at least one monitoring occasion corresponding to the collision between the LP-WUS occasion and the LP-SS occasion.

Aspect 38: The method of Aspect 37, wherein the LP-WUS occasion comprises a discontinuous transmission (DTX) occasion corresponding to a DTX configuration associated with transmitting one or more LP-WUSs, including the LP-WUS.

Aspect 39: The method of Aspect 38, wherein the DTX configuration corresponds to at least one additional monitoring occasion associated with an additional LP-WUS occasion that does not collide, in the time domain, with any LP-SS occasion.

Aspect 40: The method of any of Aspects 37-39, wherein the GTS indication is based on no paging indication being transmitted during the LP-WUS occasion.

Aspect 41: The method of any of Aspects 37-40, wherein receiving the GTS indication comprises receiving a GTS signal having a format corresponding to a format configured for transmission of the LP-WUS.

Aspect 42: The method of any of Aspects 37-41, wherein the GTS indication corresponds to a GTS configuration associated with a first periodicity, and wherein the LP-SS occasion corresponds to an LP-SS configuration associated with a second periodicity that is greater than the first periodicity.

Aspect 43: The method of any of Aspects 26-42, wherein the LP monitoring configuration comprises a radio resource management (RRM) measurement configuration associated with the LP-WUS.

Aspect 44: The method of Aspect 43, wherein the LP monitoring configuration indicates a power ratio associated with the LP-WUS and the LP-SS.

Aspect 45: The method of any of Aspects 26-44, wherein transmitting the at least one of the LP-WUS or the LP-SS comprises transmitting the LP-WUS and the LP-SS.

Aspect 46: The method of any of Aspects 26-45, wherein the at least one monitoring occasion corresponds to the collision based on a relationship between a switching time and a starting time of the LP-WUS occasion.

Aspect 47: The method of Aspect 46, wherein the switching time comprises a quantity of symbols, and wherein the at least one monitoring occasion corresponds to the collision based on the starting time of the LP-WUS occasion occurring within a first time period or a second time period, wherein the first time period comprises the quantity of symbols and ends with an ending symbol that is adjacent, in the time domain, to a starting symbol of the LP-SS occasion, and wherein the second time period comprises the quantity of symbols and starts with a starting symbol adjacent, in the time domain, to an ending symbol of the LP-SS occasion.

Aspect 48: The method of either of Aspects 46 or 47, wherein the switching time is fixed.

Aspect 49: The method of any of Aspects 46-48, further comprising receiving UE capability information that indicates the switching time.

Aspect 50: The method of any of Aspects 26-49, further comprising transmitting configuration information that indicates the LP monitoring configuration.

Aspect 51: An apparatus for wireless communication at a device, comprising a processor; memory coupled with the processor; and instructions stored in the memory and executable by the processor to cause the apparatus to perform the method of one or more of Aspects 1-25.

Aspect 52: A device for wireless communication, comprising a memory and one or more processors coupled to the memory, the one or more processors configured to perform the method of one or more of Aspects 1-25.

Aspect 53: An apparatus for wireless communication, comprising at least one means for performing the method of one or more of Aspects 1-25.

Aspect 54: A non-transitory computer-readable medium storing code for wireless communication, the code comprising instructions executable by a processor to perform the method of one or more of Aspects 1-25.

Aspect 55: A non-transitory computer-readable medium storing a set of instructions for wireless communication, the set of instructions comprising one or more instructions that, when executed by one or more processors of a device, cause the device to perform the method of one or more of Aspects 1-25.

Aspect 56: An apparatus for wireless communication at a device, comprising a processor; memory coupled with the processor; and instructions stored in the memory and executable by the processor to cause the apparatus to perform the method of one or more of Aspects 26-50.

Aspect 57: A device for wireless communication, comprising a memory and one or more processors coupled to the memory, the one or more processors configured to perform the method of one or more of Aspects 26-50.

Aspect 58: An apparatus for wireless communication, comprising at least one means for performing the method of one or more of Aspects 26-50.

Aspect 59: A non-transitory computer-readable medium storing code for wireless communication, the code comprising instructions executable by a processor to perform the method of one or more of Aspects 26-50.

Aspect 60: A non-transitory computer-readable medium storing a set of instructions for wireless communication, the set of instructions comprising one or more instructions that, when executed by one or more processors of a device, cause the device to perform the method of one or more of Aspects 26-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors coupled to the memory and configured to cause the UE to:
monitor, using a low-power (LP) wake-up-radio (LP-WUR) and based on an LP monitoring configuration, at least one of an LP-wake-up-signal (LP-WUS) occasion or an LP-synchronization-signal (LP-SS) occasion during at least one monitoring occasion, wherein the at least one monitoring occasion corresponds to a collision, in a time domain, between the LP-WUS occasion and the LP-SS occasion; and
receive the at least one of an LP-WUS or an LP-SS during the at least one monitoring occasion.

2. The UE of claim 1, wherein the LP monitoring configuration indicates a first monitoring priority associated with the LP-WUS occasion and a second monitoring priority associated with the LP-SS occasion.

3. The UE of claim 2, wherein the first monitoring priority is higher than the second monitoring priority.

4. The UE of claim 2, wherein the LP monitoring configuration indicates a prioritization timer, wherein a prioritization associated with the first monitoring priority and the second monitoring priority is based on the prioritization timer.

5. The UE of claim 4, wherein the one or more processors are further configured to cause the UE to:
receive, during a prior monitoring occasion occurring before the at least one monitoring occasion, a first LP-SS; and
start the prioritization timer based on receiving the first LP-SS, wherein the first monitoring priority is higher than the second monitoring priority based on the at least one monitoring occasion occurring prior to expiration of the prioritization timer.

6. The UE of claim 4, wherein the LP monitoring configuration indicates an initial value of the prioritization timer.

7. The UE of claim 6, wherein the initial value of the prioritization timer corresponds to one or more LP-SS periodicity values.

8. The UE of claim 4, wherein the LP monitoring configuration indicates an LP-WUS configuration for synchronization of the UE with a network node, wherein the one or more processors are further configured to cause the UE to start the prioritization timer based on receiving a first LP-WUS.

9. The UE of claim 2, wherein the one or more processors are further configured to cause the UE to transmit UE capability information that indicates at least one capability of the UE for supporting an LP monitoring configuration, wherein a prioritization associated with the first monitoring priority and the second monitoring priority is based on the at least one capability.

10. The UE of claim 9, wherein the at least one capability comprises a capability for supporting simultaneous reception, using the LP-WUR, of the LP-SS and the LP-WUS, and wherein the first monitoring priority is equal to the second monitoring priority based on the at least one capability.

11. The UE of claim 9, wherein the at least one capability comprises a capability for supporting activation of a non-LP radio based on a collision between the LP-WUS occasion and the LP-SS occasion, wherein the activation of the non-LP radio comprises activation of the non-LP radio to monitor at least one of a synchronization signal block occasion, a physical downlink control channel (PDCCH)-based paging early indicator occasion, or a paging PDCCH occasion.

12. The UE of claim 1, wherein the one or more processors are further configured to cause the UE to:
receive a go-to-sleep (GTS) indication associated with the at least one monitoring occasion based on the at least one monitoring occasion corresponding to the collision between the LP-WUS occasion and the LP-SS occasion; and
transition the LP-WUR to a sleep state based on receiving the GTS indication.

13. The UE of claim 12, wherein the LP-WUS occasion comprises a discontinuous transmission (DTX) occasion corresponding to a DTX configuration associated with transmitting one or more LP-WUSs, including the LP-WUS.

14. The UE of claim 13, wherein the DTX configuration corresponds to at least one additional monitoring occasion associated with an additional LP-WUS occasion that does not collide, in the time domain, with any LP-SS occasion.

15. The UE of claim 12, wherein the GTS indication is based on no paging indication being transmitted during the LP-WUS occasion.

16. The UE of claim 12, wherein the one or more processors, to cause the UE to receive the GTS indication, are configured to cause the UE to receive a GTS signal having a format corresponding to a format configured for transmission of the LP-WUS.

17. The UE of claim 12, wherein the GTS indication corresponds to a GTS configuration associated with a first periodicity, and wherein the LP-SS occasion corresponds to an LP-SS configuration associated with a second periodicity that is greater than the first periodicity.

18. The UE of claim 1, wherein the LP monitoring configuration comprises a radio resource management (RRM) measurement configuration associated with the LP-WUS.

19. The UE of claim 18, wherein the LP monitoring configuration indicates a power ratio associated with the LP-WUS and the LP-SS.

20. The UE of claim 19, wherein the one or more processors, to cause the UE to receive the at least one of the LP-WUS or the LP-SS, are configured to cause the UE to receive the LP-WUS and the LP-SS, and wherein the one or more processors are further configured to cause the UE to:
obtain a first RRM measurement associated with the LP-WUS;
obtain a second RRM measurement associated with the LP-SS; and
generate, based on the power ratio, an RRM measurement result based on a combination of the first RRM measurement and the second RRM measurement.

21. The UE of claim 1, wherein the at least one monitoring occasion corresponds to the collision based on a relationship between a switching time and a starting time of the LP-WUS occasion.

22. The UE of claim 21, wherein the switching time comprises a quantity of symbols, and wherein the at least one monitoring occasion corresponds to the collision based on the starting time of the LP-WUS occasion occurring within a first time period or a second time period, wherein the first time period comprises the quantity of symbols and ends with an ending symbol that is adjacent, in the time domain, to a starting symbol of the LP-SS occasion, and wherein the second time period comprises the quantity of symbols and starts with a starting symbol adjacent, in the time domain, to an ending symbol of the LP-SS occasion.

23. The UE of claim 22, wherein the switching time is fixed.

24. The UE of claim 22, wherein the one or more processors are further configured to cause the UE to transmit UE capability information that indicates the switching time.

25. A network node for wireless communication, comprising:
a memory; and
one or more processors coupled to the memory and configured to cause the network node to:
transmit, to a user equipment (UE) comprising a low-power (LP) wake-up-radio (LP-WUR), configuration information indicative of an LP monitoring configuration corresponding to a monitoring operation associated with at least one of an LP-wake-up-signal (LP-WUS) occasion or an LP-synchronization-signal (LP-SS) occasion; and
transmit at least one of an LP-WUS or an LP-SS during at least one monitoring occasion, wherein the at least one monitoring occasion corresponds to a collision, in a time domain, between the LP-WUS occasion and the LP-SS occasion.

26. The network node of claim 25, wherein the LP monitoring configuration indicates a first monitoring priority associated with the LP-WUS occasion and a second monitoring priority associated with the LP-SS occasion.

27. A method of wireless communication performed by a user equipment (UE), comprising:
monitoring, using a low-power (LP) wake-up-radio (LP-WUR) and based on an LP monitoring configuration, at least one of an LP-wake-up-signal (LP-WUS) occasion or an LP-synchronization-signal (LP-SS) occasion during at least one monitoring occasion, wherein the at least one monitoring occasion corresponds to a collision, in a time domain, between the LP-WUS occasion and the LP-SS occasion; and
receiving the at least one of an LP-WUS or an LP-SS during the at least one monitoring occasion.

28. The method of claim 27, wherein the LP monitoring configuration indicates a first monitoring priority associated with the LP-WUS occasion and a second monitoring priority associated with the LP-SS occasion.

29. A method of wireless communication performed by a network node, comprising:
transmitting, to a user equipment (UE) comprising a low-power (LP) wake-up-radio (LP-WUR), configuration information indicative of an LP monitoring configuration corresponding to a monitoring operation associated with at least one of an LP-wake-up-signal (LP-WUS) occasion or an LP-synchronization-signal (LP-SS) occasion; and
transmitting at least one of an LP-WUS or an LP-SS during at least one monitoring occasion, wherein the at least one monitoring occasion corresponds to a collision, in a time domain, between the LP-WUS occasion and the LP-SS occasion.

30. The method of claim 29, wherein the LP monitoring configuration indicates a first monitoring priority associated with the LP-WUS occasion and a second monitoring priority associated with the LP-SS occasion.
